(19) United States
(12) Patent Application Publication
(10) Pub. No.: US 2026/0104342 A1
(43) Pub. Date: Apr. 16, 2026

(54) BIOLOGICAL PARTICLE ANALYZER

(71) Applicant: Beckman Coulter, Inc., Brea, CA (US)

(72) Inventors: Vinay Prathapan, Miami, FL (US); Rishon Rodrigues, Miami, FL (US)

(21) Appl. No.: 19/351,865

(22) Filed: Oct. 7, 2025

Related U.S. Application Data
(60) Provisional application No. 63/707,472, filed on Oct. 15, 2024.

(51) Int. Cl. G01N 15/1409; G01N 15/01; G01N 15/10; G01N 15/1404; G01N 15/1434

(52) U.S. Cl. CPC G01N 15/1409; G01N 15/01; G01N 15/1436; G01N 2015/1006; G01N 2015/142

(57) ABSTRACT

A biological particle analysis system comprises: a flowcell; a vibration transducer module configured to cause movement of particles in a biological sample through the flowcell; and a camera configured to image the particles of the biological sample at an imaging region of the flowcell.

### CROSS REFERENCE TO RELATED APPLICATIONS

This application claims priority to U.S. Application No. 63/707,472 filed Oct. 15, 2024, which is herein incorporated by reference in its entirety.

### BACKGROUND

Generally, this application relates to instruments/analyzers used for biological analysis incorporating imaging (hereinafter, biological analyzers or biological particle analyzers). In some examples, the biological analyzers analyze biological particles, including biological cellular material, such as particles or cells in blood or urine.

### SUMMARY

According to embodiments, a biological particle analysis system comprises: a flowcell; a vibration transducer module configured to cause movement of particles in a biological sample through the flowcell; and a camera configured to image the particles of the biological sample at an imaging region of the flowcell.

According to an embodiment, the vibration transducer module may be configured to be energized with a waveform having a positive cycle and a negative cycle, wherein the positive cycle and the negative cycle are different from each other.

According to an embodiment, the biological sample may include the particles suspended in a fluid, wherein the vibration transducer module may be configured to cause the particles to translate and to cause the fluid to oscillate.

According to an embodiment, the translation of the particles may be towards the camera when the vibration transducer module is activated according to a first mode; and the translation of the particles may be away from the camera when the vibration transducer module is activated according to a second mode.

According to an embodiment, the movement of the particles may comprise angular movement of the particles that causes a given particle to move into a plurality of angular positions, and the camera may be configured to obtain a plurality of images of the given particle in the plurality of angular positions to identify the given particle.

According to an embodiment, the vibration transducer module may comprise a first transducer element opposing a second transducer element, wherein each of the first transducer element and the second transducer element emit an ultrasonic wave across a channel in the vibration transducer module through which the biological sample flows.

According to an embodiment, the vibration transducer module may generate vibrations at least one predominant frequency in a range from 10 kHz and 40 kHz.

According to an embodiment, the biological sample may be a urine sample.

According to an embodiment, the biological sample may be a blood sample.

According to an embodiment, the vibration transducer module may include: a first end of a channel; a second end of the channel, wherein the channel is configured to allow a flow of particles in the biological sample through the first end and the second end; and a vibration transducer element configured to emit vibrations towards the channel to cause the particles to translate through the channel towards one of the first end or the second end.

According to an embodiment, the vibration transducer module may be configured to: cause the particles to translate through the channel towards the first end when the vibration transducer element is energized in a first mode; and cause the particles to translate through the channel towards the second end when the vibration transducer element is energized in a second mode.

According to an embodiment, the biological particle analysis system may further comprise a reservoir configured to contain the biological sample, wherein the reservoir may be proximate to the first end of the channel.

According to an embodiment, the vibration transducer module may be configured to be non-destructively removed from the biological particle analysis system.

According to embodiments, a computer-implemented method of biological particle analysis comprises: providing a flowcell of a biological analyzer configured to receive a biological sample; providing a vibration transducer module configured to cause movement of particles in the biological sample through the flowcell; and capturing images of the particles in the biological sample at an imaging region of the flowcell.

According to an embodiment, the vibration transducer module may be further configured to energize the vibration transducer module with a waveform having a positive cycle and a negative cycle, wherein the positive cycle and the negative cycle are different from each other.

According to an embodiment, the biological sample may include the particles suspended in a fluid, wherein the vibration transducer module is further configured to cause the particles to translate and the fluid to oscillate.

According to an embodiment: the movement of the particles may include a translation of the particles towards the imager when the vibration transducer module is activated according to a first mode; and the movement of the particles may include a translation of the particles away from the imager when the vibration transducer module is activated according to a second mode.

According to an embodiment: the movement of the particles may comprise angular movement of the particles that causes a given particle to move into a plurality of angular positions; and said imaging the particles may comprise obtaining a plurality of images of the given particle in the plurality of angular positions to identify the given particle.

According to an embodiment, the vibration transducer module may comprise a first transducer element opposing a second transducer element, wherein each of the first transducer element and the second transducer element emit an ultrasonic wave across a channel in the vibration transducer module through which the biological sample flows.

According to an embodiment, the vibration transducer module may generate vibrations at least one predominant frequency between 10 kHz and 40 kHz.

### BRIEF DESCRIPTION OF SEVERAL VIEWS OF THE DRAWINGS

FIG. 1 illustrates a block diagram of a biological particle analyzer, according to embodiments.

FIG. 2A illustrates a perspective view of a vibration transducer module, according to embodiments.

FIG. 2B illustrates a perspective, cross-sectional view of the vibration transducer module of FIG. 2A, according to embodiments.

FIG. 3 is a flowchart for a method of performing biological particle analysis, according to embodiments.

FIG. 4 illustrates a block diagram of a urinalysis module, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

Certain techniques described herein relate to particle imaging in a biological particle analyzer. One type of biological particle analyzer uses an imager, such as one including camera or optical sensing device, to obtain images of biological particles suspended in fluid in a sample. Such samples can be, for example, blood samples (e.g., human blood) or urine samples (e.g., human urine). In the case of a blood sample, a given sample may include various types of particles, such as an erythrocyte, a reticulocyte, a nucleated red blood cell, a platelet, or a white blood cell. In the case of a urine sample, a given sample may include particles such as a red blood cell or a crystal.

In flow microscopy, images of particles of interest in a sample can be captured to identify and count the particles. This can take place using discrete fluidic pumps to flow the particles en masse through a flowcell which shapes and stages the sample stream, sandwiched between a sheathing carrier fluid which is pumped into the flow cell simultaneously, to capture images of the particles stabilized within the core stream, with the necessary magnification and illumination. The flow of the sheathing carrier fluid and the sample induces particle motion, and this motion is a bulk phenomenon which limits the controllability of the flow of the particles to the precision of the discrete fluidic pumps used. Additionally, as the bulk flow of the particles is a consequence of the carrier fluid's motion, analysis of the sample is vulnerable to the disturbances in the flow path of the sheathing carrier fluid and sample, which may be difficult to control. As described herein, a vibration transducer module can supplement or replace such pumps to address such issues.

In this method of inducing particle motion within a sample, electronically controlled, shaped waveforms generated by a vibration transducer module (e.g., vibration transducer module 130, discussed below) in turn induces vibrations in the sample with asymmetrical displacements of the medium in opposing directions from the mean, for each cycle, causing particles of interest to respond selectively to each phase of the vibration and cause them to translate depending on the kinetic energy absorbed. These vibrations can traverse across the entire length of the fluidic column (e.g., the channel in the vibration transducer module, such as channel 136, discussed below), and by placing a flowcell (e.g., flowcell 124, discussed below) in the path for the optical elements to focus on the sample stream, high resolution images of the particles of interest in the sample can be successfully captured and used for screening/diagnostic analysis using particle recognition software (e.g., a machine learning model) trained specifically for the samples of interest. Additionally, by shaping the bias (amplitude and/or shape for each half cycle of the waveform) and/or frequency characteristics of the waveform, it may be possible to hold or move the particles of interest selectively for further analysis, thereby improving the means to perform a diagnosis of the sample by allowing a significantly higher degree of control of the particles in the medium for image acquisition and other analysis processes than existing microfluidic methods involving bulk flow allows. As such, a high order of precision with which particles can be located/moved within a fluidic carrier medium is enabled by the application of this technology.

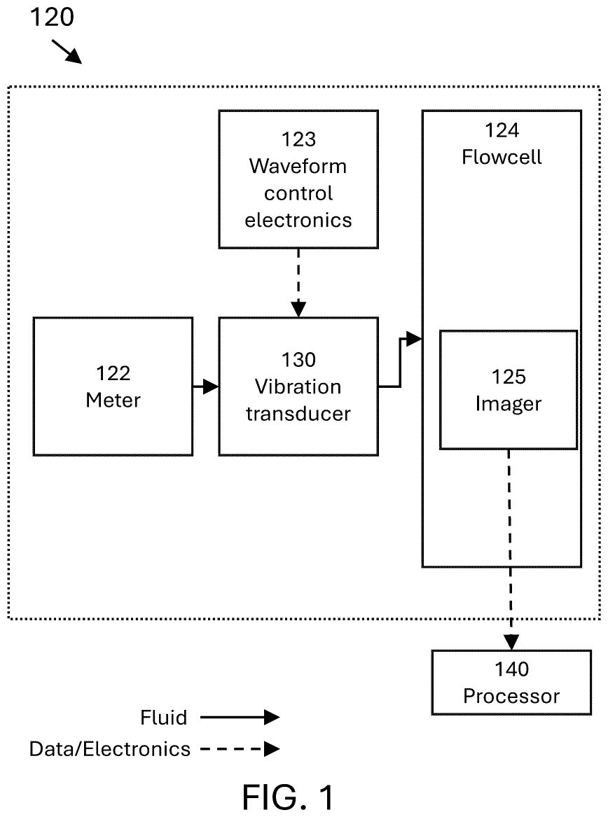

FIG. 1 illustrates a block diagram of a biological particle analyzer 120 and a processor 140. These components may form or may be part of a biological particle analysis system. The biological particle analyzer 120 may be a flow-based particle imaging system for flow microscopy. The biological particle analyzer 120 may implement methods to selectively displace, locomote, or move particles (e.g., microscopic particles of diagnostic relevance) in a fluid or fluidized sample medium. The particles may be moved using vibration transducer(s) 130 that are energized with particular waveforms. The particles, once moved, can be imaged using an imager 125 (e.g., one including opto-electronic elements), and the resulting images can be analyzed by the processor 140 to identify the particles. The biological particle analyzer 120 may be relatively compact and portable. The biological particle analyzer 120 may be larger, for example, located at point-of-care clinics or as large-scale diagnostic laboratory-scale instruments.

The biological particle analyzer 120 can be used to analyze a biological sample, such as a blood sample or a urine sample. Particularly, the biological particle analyzer 120 can be used to analyze particles in a biological sample. The biological particle analyzer 120 may include a meter 122, a vibration transducer 130, a flowcell 124, and/or an imager 125. The biological particle analyzer 120 performs fluidic and imaging operations to generate images of particles of clinical relevance and communicate the images to the processor 140. The operations of the biological particle analyzer 120 may be controlled by the processor 140.

The meter 122 controls the rate of fluid flow, at least partially, into or through the biological particle analyzer 120 as it is pumped. The metered fluid may be the sample or cleanser fluid. The meter 122 may be controlled by the processor 140 to adjust whether fluid flows through the meter 122 or the rate that the fluid flows. The meter 122 may include sensor(s) that sense the rate of fluid flows and provide that information to the processor 140. The meter 122 may be bidirectional (allow fluid to flow either way through the meter 122) or may be unidirectional (e.g., include a one-way flow valve).

The biological particle analyzer 120 may further include one or more pumps (not shown). The pump(s) operate to convey a sample to flow through the fluidic lines to the flowcell 124. The pump(s) may further operate to convey the cleanser fluid through the biological particle analyzer 120 to clean the biological particle analyzer 120 and prepare it for subsequent sample analysis.

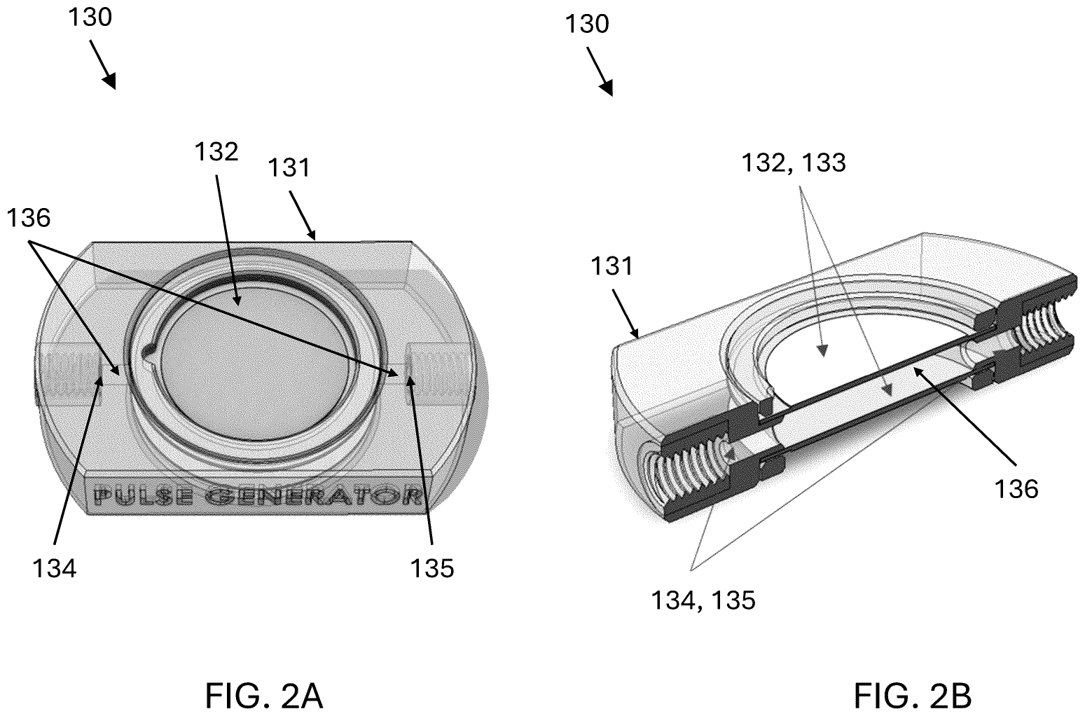

The vibration transducer (or vibration transducer module) 130 receives the fluid after the fluid has been metered by meter 122 and/or pumped by the pump(s). An embodiment of the vibration transducer 130 is illustrated in FIGS. 2A and 2B. FIG. 2A illustrates a perspective view of the vibration transducer module 130. FIG. 2B illustrates a perspective, cross-sectional view of the vibration transducer module 130.

The vibration transducer 130 includes a body 131 that receives one or more transducer elements (two transducer elements 132, 133 are shown). The body 131 forms a first port or first end 134 and a second port or second end 135. The body 131 may receive fluidic connectors (e.g., tubes or interfaces). The body 131 may include feature(s) to receive the fluidic connectors, such as the threaded regions depicted. The body 131 further forms a channel 136 that couples the first end 134 with the second end 135, such that fluid can flow therethrough. The vibration transducer 130 may be non-destructively removable from the biological particle analyzer 120.

The transducer element(s) 132, 133 may be piezoelectric devices and may be oriented to primarily direct outputted vibrations or waves towards the channel 136. The transducer element(s) 132, 133 may be flat or may have a non-planar contour. For example, the transducer element(s) 132, 133 may be curved and tend to wrap around the channel 136, circumferentially. The transducer element(s) 132, 133 are energized by waveform control electronics 123, which provide electrical signals to input(s) of the transducer element(s) 132, 133. The processor 140 controls the waveform control electronics 123 to effect the generation of an electrical signals to cause the waves.

The same (or different) electrical signal may be provided to two or more transducer element(s) 132, 133 when there is a plurality of transducer elements 132, 133. Although two transducer elements 132, 133 are shown, any reasonable number of transducer elements may be employed. The transducer elements 132, 133 may oppose each other, as depicted, or may be in another arrangement. Having multiple transducer elements 132, 133 can increase the amount of energy imparted to the sample (via sonic wave(s), such as an ultrasonic wave(s)) in the channel 136 and/or more evenly distribute the imparted energy across the sample.

The transducer element(s) 132, 133 generate vibrations to emit waves (e.g., ultrasonic waves). The waves may have a predominant frequency or at least one predominant frequency in a range from 20 kHz to 40 kHz or in a range from 10 kHz to 40 kHz. A given wave may have a period and a positive and negative cycle therein. The positive and negative cycles may differ. For example, the wave may be a sawtooth wave with non-zero symmetry, such as 95% symmetry. In such a manner, the vibration transducer 130 may operate in a first mode. The positive cycle and the negative cycle may be reversed. In such a manner, the vibration transducer 130 may operate in a second mode. To determine a given mode of operation, a wave may be selected with a given bias. The positive and negative cycles of the wave may have different shapes (e.g., sawtooth, square, sine, or irregular) and/or different amplitudes. According to an embodiment, a wave may be a sawtooth wave and may have a predetermined amplitude, such as +/−600 mV.

The vibrations imparted to the sample by the transducer element(s) 132, 133 may cause the particles in the sample to move. The fluid oscillates corresponding to the frequenc(ies), amplitudes, and/or shapes, of the wave. The suspended particles translate (and potentially rotate) with respect to the oscillating fluid. The particles may translate by differing degrees according to the given masses of the particles. For example, a lower frequency wave may cause heavier particles to translate farther than lighter particles. In contrast, a higher frequency wave may cause lighter particles to translate farther than heavier particles. When the vibration transducer 130 operates in the first mode, the particles may translate towards the flowcell 124, whereas when the vibration transducer 130 operates in the second mode, the particles may translate away from the flowcell 124. The waves may further impart angular momentums to the particles, causing them to rotate. The angular momentums of the particles may vary according to the frequency of the wave. For example, a lower frequency wave may impart a greater angular momentum to heavier particles than lighter particles. In contrast, a higher frequency wave may impart a greater angular momentum to lighter particles as compared to heavier particles. The particles may be rotating when they enter and travel through the flowcell 124 due to this impartation of angular momentum. Thus, the particles may be rotating when they are imaged by the imager 125, as further discussed below.

The vibration transducer 130 may further impart motion to cleanser fluid. The cleanser fluid may responsively oscillate, as with the fluid in the sample. The biological particle analyzer 120 may further include a pump to effect forward motion of the cleanser fluid through the system such that the system may be cleaned and prepared for subsequent use.

The sample and/or cleanser fluid may be static (i.e., not flowing) or may be flowing when vibrations are imparted by the vibration transducer element(s) 132, 133. As another example, the sample and/or cleanser fluid may be flowing (either towards the flowcell 124 or away from the flowcell 124), for example, at a rate such as less than or equal to 2 μL/minute. Techniques described herein may be performed effectively whether the sample and/or fluid is static or flowing at a suitable rate.

The flowcell 124 may be a component such as the flowcell described in U.S. Pat. No. 9,322,752, filed on Mar. 17, 2014, the entirety of which is incorporated by reference herein. However, the flowcell 124 may not use sheath fluid (and associated componentry) to convey the sample through the flowcell 124. Instead, or possibly in addition, the particles may translate from the energy imparted by the vibration transducer 130 such that they travel through the flowcell 124. According to the previous discussion, the particles may translate forwardly or backwardly through the flowcell 124. Operations of the flowcell 124 may be controlled and monitored by the processor 140. As the processor 140 controls the waveform control electronics 123, the processor 140 can select waves to cause forward or backward translation of the particles through the flowcell 124. The processor 140 can further select waves that cause faster movement of certain particles as compared to other particles, according to the masses of the particles. For example, if a given type of particle that has a given typical range of masses is to be analyzed, the processor 140 may select a wave to cause greater translation of this type of particle. In such a way, the given type of particle will tend to separate from the other particles in the sample fluid—i.e., translate more rapidly. The processor 140 may select waves with multiple frequencies to selectively translate multiple types of particles at different speeds. For example, when there are three types of particles of clinical relevance to be analyzed, a wave may be selected to move the first type of particle at a high speed, to move the second type of particle at a moderate speed, and to move the third type of particle at a slow speed. In such a way, the different particles will tend to flow through the flowcell 124 such that the first type of particle tends to be before the second type of particle (the first type of particle tends to arrive and flow through the flowcell 124 earlier), which tends to be before the third type of particle.

The flowcell 124 includes an imager 125, such as a camera or opto-electronic componentry. The imager 125 obtains images of the particles as they travel through the flowcell 124. The imager 125 may obtain multiple images of a given particle as it rotates according to its angular momentum, such that different images are from different perspectives with respect to the particle. These images are communicated to the processor 140.

The processor 140 may include one or more processors. Some or all of the processors may be collocated (e.g., integrated together on a single ASIC) or some or all of the processors may be distributed at different locations, including location(s) within and/or remote from the biological particle analyzer 120. The processor 140 controls the operation of the biological particle analyzer 120, including causing components to function in particular manners and sensing operational aspects of the biological particle analyzer 120. The processor 140 receives image data from the imager 125 and processes the images to identify and count particles of clinical relevance in the sample. The processor 140 may identify particles by various image processing algorithms. For example, the processor 140 may use a trained machine learning model to identify given particles.

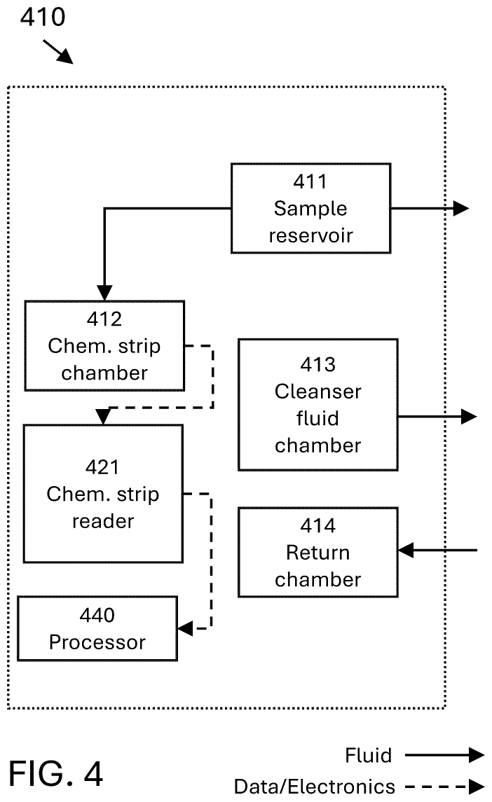

FIG. 4 illustrates a block diagram of a urinalysis module 410, according to embodiments. The urinalysis module 410 may be part of the biological particle analysis system inclusive of the biological particle analyzer 120 and processor 140. In the case that the biological particle analyzer 120 analyzes particles in urine samples, a urinalysis module 410 may be provided to operate in conjunction with the biological particle analyzer 120. The urinalysis module 410 may be a physically separate instrument from the biological particle analyzer 120. For example, the urinalysis module 410 and the biological particle analyzer 120 may be separate instruments in a workcell, and the urinalysis module 410 may be upstream from the biological particle analyzer 120 in the workcell flow.

Optionally, the urinalysis module 410 may be a sample collection cartridge. The urinalysis module 410 may be modular and may be insertable and removable in/out of the biological particle analyzer 120 (e.g., insertable/removable manually by an operator without tools). Insertion and removal of the cartridge may be non-destructive to the biological particle analyzer 120. The cartridge may be for single use and may be disposable.

The urinalysis module 410 may include one or more chambers or reservoirs, including a sample reservoir 411, a cleanser-fluid chamber 413, and/or a return chamber 414. Before analyzing biological particles, the sample reservoir 411 contains a sample from a patient (e.g., urine sample collected from a human). The sample includes a fluid with suspended particles. The cleanser-fluid chamber 413 is pre-filled with cleanser fluid, which can rinse or prepare the biological particle analyzer 120 (via fluid line(s) not shown) before analyzing the sample. The return chamber 414 serves as a waste reservoir to collect the analyzed sample (from the biological particle analyzer 120, via fluid line(s), not shown) and/or cleanser fluid after use.

The urinalysis module 410 may further include a chemistry strip chamber 412. The chemistry strip chamber 412 may be sealed and may have an embedded urine chemistry analysis strip. The strip can be wetted with sample (e.g., at the time of analysis) when the chemistry strip chamber 412 receives the sample from the sample reservoir 411. The flow of the sample from the sample reservoir 411 to the chemistry strip chamber 412 may be controlled by a port or valve that is closed until the time of analysis, at which time the port/valve is opened to allow flow of the sample.

The biological particle analyzer 120 may be fluidically coupled with the urinalysis module 410. Further, one or more of the aforementioned pump(s) may be located in the urinalysis module 410.

The sample and/or cleanser fluid may be caused to flow into the return chamber 414 (e.g., via one or more pumps, not shown). Once these fluid(s) have been received at the return chamber 414, analysis may be complete, and the urinalysis module 410 (if a cartridge) can be removed from the biological particle analyzer 120 and disposed of.

The urinalysis module 410 may further include a chemistry strip reader 421. For example, for urine chemistry, the chemistry strip reader 421 includes actuation mechanisms to activate the chemistry strip chamber 412 with the chemistry analysis strip and may further include a camera and calibrated light source to read the color changes in the strip as a function of the chemistry of the urine sample. The chemistry information obtained by the camera is communicated to the processor 440 for assessment.

The processor 440 may include one or more processors. Some or all of the processors may be collocated (e.g., integrated together on a single ASIC) or some or all of the processors may be distributed at different locations, including location(s) within and/or remote from the urinalysis module 410. The processor 440 can control the operation of the urinalysis module 410, including causing components to function in particular manners and sensing operational aspects of the urinalysis module 410. The processor 440 may be the same as or may share processing functionality with the processor 140.

Although the urinalysis module 410 is shown with fluidic lines entering and leaving, there may be no such lines if the urinalysis module 410 is a standalone instrument, such as an instrument in a workcell with the biological particle analyzer 120. In such a configuration, the urinalysis module 410 may not provide the sample to the biological particle analyzer 120 directly from the sample reservoir 411. The urinalysis module 410 may not provide cleanser fluid to the biological particle analyzer 120 via a cleanser fluid chamber 413. The urinalysis module 410 may not receive waste from the biological particle analyzer 120.

In some embodiments, the urinalysis module 410 may be partially or fully integrated with the biological particle analyzer 120. For example, the collective components of the urinalysis module 410 and the biological particle analyzer 120 may be housed in a single housing or multiple abutting housings.

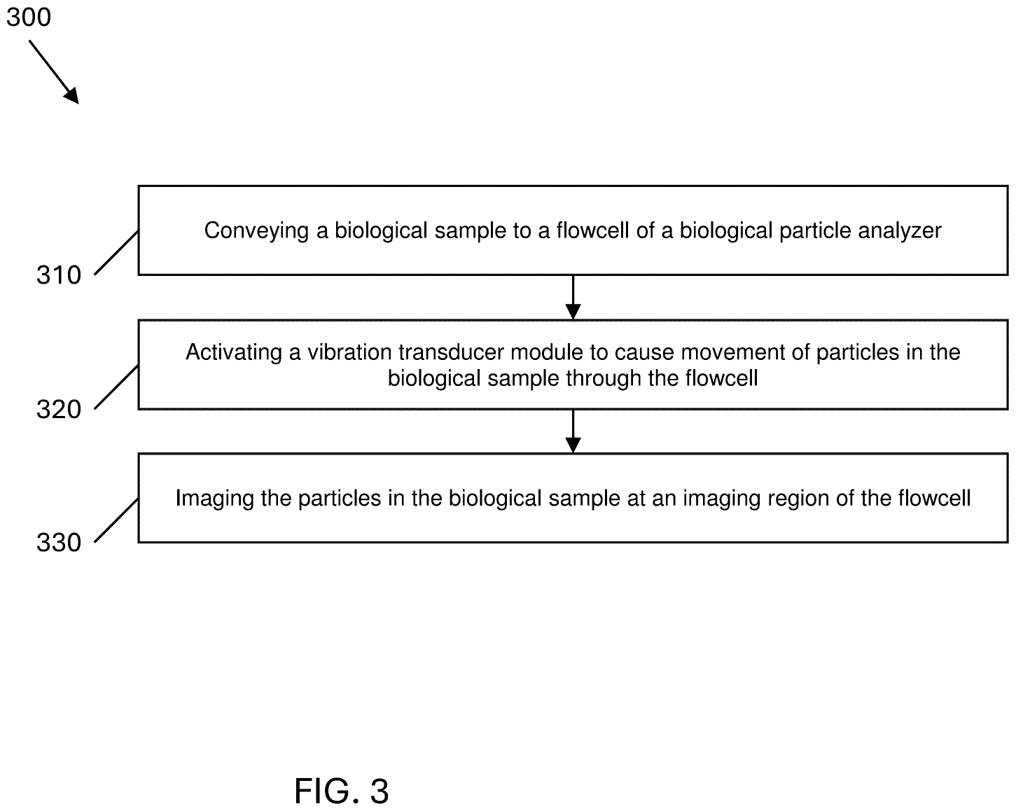

FIG. 3 is a flowchart 300 for a method of biological particle analysis. The steps in flowchart 300 may be performed by a biological particle analyzer, such as biological particle analyzer 120. The steps in flowchart 300 may be implemented or facilitated by a processor, such as processor(s) 140, 440. The steps may be performed when the processor executes instructions stored on a computer-readable memory (e.g., a non-transitory memory). The steps may be performed in sequence as shown, in a different sequence, and/or some of the steps may be performed in parallel or may overlap. Flowchart 300 is described in conjunction with the above-described figures, but is not so limited. In the following example, a urine sample is analyzed, and the urinalysis module 410 is employed, but the method is not so-limited.

At step 310, a biological sample is conveyed to a flowcell 124. The biological sample may be conveyed to the flowcell 124 via pump(s) (not shown). The biological sample may originate in the urinalysis module 410, and specifically the sample reservoir 411. The biological sample may be conveyed by pump(s) in the biological particle analyzer 120 and/or the urinalysis module 410. The processor 140 operates to cause the sample to be conveyed to the flowcell 124. The sample may also be conveyed to other components, including the meter 122 and vibration transducer 130.

At step 320, a vibration transducer module 130 is activated, thereby causing movement of particles in the biological sample to move through the flowcell 124. After the sample arrives at the vibration transducer module 130, electrical signals are generated by the waveform control electronics 123 and provided to the vibration transducer module 130. The vibration transducer module 130 causes vibrations via the transducer element(s) 132, 133 that act on the sample in the channel 136, as described above. The processor 140 operates to cause the vibration transducer module 130 to act on the sample therewithin. The suspended particles translate (and can rotate) in response to the vibrations of the transducer element(s) 132, 133.

At step 330, the particles in the biological sample are imaged at an imaging region of the flowcell 124 at the imager 125. After the particles in the sample have been translated from the vibration transducer 130 to an imaging region in the flowcell 124, the imager obtains images of the particles. The processor causes the imager 125 to obtain images of the particles in the imaging region of the flowcell 124. The image data from the imager 125 is communicated to the processor 140, where the particles are identified and/or counted.

In one illustrative example, the sample is collected directly from the patient (or poured in from a collection cup) into the urinalysis module 410. In this example, the urinalysis module 410 is a cartridge. Depending on logistics available, the urinalysis module 410 is either shipped to a collection center or readied for analysis at a point-of-care facility. The urinalysis module 410 is placed in the biological particle analyzer 120, thereby engaging all mechanical, fluidic and electrical interfaces securely between the urinalysis module 410, biological particle analyzer 120, and optionally the processor 140. The processor 140 causes pump(s) in the biological particle analyzer 120 to draw the sample from the sample reservoir 411 in the urinalysis module 410, and stages the sample into the meter 122, thereby promoting a relatively precise volume of sample drawn into the biological particle analyzer 120 for processing. When the sample is ready for analysis, the vibration transducer module 130 is activated by the processor 140 to produce waveforms that induce particles within the staged sample to translate into the flowcell 124 and allow them to be captured photographically by the imager 125 comprising of microscopy optics and camera sensor electronics. The images are communicated to the processor 140. Once the sample is analyzed, the urinalysis module 410 is engaged (via pump(s) in the biological particle analyzer 120) to fill fluidic lines in the sample analyzer 120 with the cleanser fluid stored in the cleanser fluid chamber 413, thereby rinsing out the meter 122, the flowcell 124 and the connecting fluid lines, and the resulting waste is collected into the return chamber 414 in the urinalysis module 410. In such a way, the urinalysis module 410 can provide both the sample and the cleaning fluid for cleaning the biological particle analyzer 120 in preparation for the next sample to be analyzed. After the processor 140 receives the image data from the imager 125, the processor 140 analyzes the image data to identify and count particles in the sample. Separately, the chemistry strip chamber 412 in the urinalysis module 410 contains urine chemistry analysis pads which react to analytes in the sample from a urine chemistry perspective, and produces transient color changes on the pads, which, via the chemistry strip reader 421 in the biological particle analyzer 120, can record the changes and supply the data to the processor 440, thereby allowing the processor to generate and compile urine chemistry results.

The operations described herein may be performed or facilitated using a computer or other processor having hardware, software, and/or firmware, such as processor 140. The various method steps may be performed or facilitated by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory) and/or a storage media (a hard disk, optical memory such as a CD, a CD-R/W, a CD-ROM, a DVD, or the like, or any other digital or analog storage media).

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted, or modified. It can be appreciated that, in certain aspects of the invention, a single component may be replaced by multiple components, and multiple components may be replaced by a single component, to provide an element or structure or to perform a given function or functions.

It will be understood by those skilled in the art that various changes may be made, and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques are not limited to the particular techniques disclosed, but that they will include all techniques falling within the scope of the appended claims.

1. A biological particle analysis system, comprising:
a flowcell;
a vibration transducer module configured to cause movement of particles in a biological sample through the flowcell; and
a camera configured to image the particles of the biological sample at an imaging region of the flowcell.

2. The biological particle analysis system of claim 1, wherein vibration transducer module is configured to be energized with a waveform having a positive cycle and a negative cycle, wherein the positive cycle and the negative cycle are different from each other.

3. The biological particle analysis system of claim 1, wherein the biological sample includes the particles suspended in a fluid, wherein the vibration transducer module is configured to cause the particles to translate and to cause the fluid to oscillate.

4. The biological particle analysis system of claim 3, wherein:
wherein the translation of the particles is towards the camera when the vibration transducer module is activated according to a first mode; and
wherein the translation of the particles is away from the camera when the vibration transducer module is activated according to a second mode.

5. The biological particle analysis system of claim 1, wherein:
wherein the movement of the particles comprises angular movement of the particles that causes a given particle to move into a plurality of angular positions; and
wherein the camera is configured to obtain a plurality of images of the given particle in the plurality of angular positions to identify the given particle.

6. The biological particle analysis system of claim 1, wherein the vibration transducer module comprises a first transducer element opposing a second transducer element, wherein each of the first transducer element and the second transducer element emit an ultrasonic wave across a channel in the vibration transducer module through which the biological sample flows.

7. The biological particle analysis system of claim 1, wherein the vibration transducer module is configured to generate vibrations with at least one predominant frequency in a range from 10 kHz to 40 kHz.

8. The biological particle analysis system of claim 1, wherein the biological sample is a urine sample.

9. The biological particle analysis system of claim 1, wherein the biological sample is a blood sample.

10. The biological particle analysis system of claim 1, wherein the vibration transducer module comprises:
a first end of a channel;
a second end of the channel, wherein the channel is configured to allow a flow of particles in the biological sample through the first end and the second end; and
a vibration transducer element configured to emit vibrations towards the channel to cause the particles to translate through the channel towards one of the first end or the second end.

11. The biological particle analysis system of claim 10, wherein the vibration transducer module is configured to:
cause the particles to translate through the channel towards the first end when the vibration transducer element is energized in a first mode; and
cause the particles to translate through the channel towards the second end when the vibration transducer element is energized in a second mode.

12. The biological particle analysis system of claim 10, further comprising a reservoir configured to contain the biological sample, wherein the reservoir is proximate to the first end of the channel.

13. The biological particle analysis system of claim 1, wherein the vibration transducer module is configured to be non-destructively removed from the biological particle analysis system.

14. A computer-implemented method of biological particle analysis, the method comprising:
providing a flowcell of a biological analyzer configured to receive a biological sample;
providing a vibration transducer module configured to cause movement of particles in the biological sample through the flowcell; and
capturing images of the particles in the biological sample at an imaging region of the flowcell.

15. The method of claim 14, wherein the vibration transducer module is further configured to energize the vibration transducer module with a waveform having a positive cycle and a negative cycle, wherein the positive cycle and the negative cycle are different from each other.

16. The method of claim 14, wherein the biological sample includes the particles suspended in a fluid, wherein the vibration transducer module is further configured to cause the particles to translate and the fluid to oscillate.

17. The method of claim 16, wherein:
the movement of the particles includes a translation of the particles towards the imager when the vibration transducer module is activated according to a first mode; and
the movement of the particles includes a translation of the particles away from the imager when the vibration transducer module is activated according to a second mode.

18. The method of claim 14, wherein:
the movement of the particles comprises angular movement of the particles that causes a given particle to move into a plurality of angular positions; and
said imaging the particles comprises obtaining a plurality of images of the given particle in the plurality of angular positions to identify the given particle.

19. The method of claim 14, wherein the vibration transducer module comprises a first transducer element opposing a second transducer element, wherein each of the first transducer element and the second transducer element emit an ultrasonic wave across a channel in the vibration transducer module through which the biological sample flows.

20. The method of claim 14, wherein the vibration transducer module is configured to generate vibrations with at least one predominant frequency in a range from 10 kHz to 40 kHz.
